(19) United States
(12) Patent Application Publication
(10) Pub. No.: US 2026/0251477 A1
(43) Pub. Date: Aug. 27, 2026

(54) SPATIAL INFORMATION OUTPUT APPARATUS, METHOD FOR OUTPUTTING SPATIAL INFORMATION AND PROGRAM THEREOF

(71) Applicants: DENSO CORPORATION, Kariya-city (JP); J-QuAD DYNAMICS Inc., Tokyo (JP)

(72) Inventors: Mana HAYAKAWA, Tokyo (JP); Hiroki UKAI, Tokyo (JP); Masahiro GOTO, Tokyo (JP)

(21) Appl. No.: 19/551,318

(22) Filed: Feb. 26, 2026

(30) Foreign Application Priority Data
Feb. 27, 2025 (JP) 2025-030476

(51) Int. Cl. G01C 21/00

(52) U.S. Cl. CPC G01C 21/3889

(57) ABSTRACT

A spatial information output apparatus is provided with an acquiring unit that acquires a map data including a location of an own vehicle and a type of a road; and an output unit that extracts a reduced map data from an extraction area of the map data, and outputs the reduced map data of the extraction area, the extraction area being from the location of the own vehicle to a setting distance in the map data, in which the output unit is configured to change the setting distance based on the type of the road on which the own vehicle is located.

### CROSS-REFERENCE TO RELATED APPLICATION

This application is based on and claims the benefit of priority from earlier Japanese Patent Application No. 2025-030476 filed February 27, 2025, the description of which is incorporated herein by reference.

### BACKGROUND

### Technical Field

The present disclosure relates to a spatial information output apparatus, a spatial information output method and a spatial information output program.

### Description of the Related Art

A map information generation apparatus that generates map information used for automatic driving control of a vehicle is known. This map information generation apparatus is provided with a location acquiring unit, a route information acquiring unit, a map information acquiring unit and a map information generation unit. The location acquiring unit acquires a current location of a vehicle. The route information acquiring unit acquires route information indicating a scheduled traveling route from the current location of the vehicle to the destination. The map information acquiring unit acquires high-precision map information. The map information generation unit acquires desired map information from the high-precision map information acquired by the map information acquiring unit based on the current location of the vehicle and the route information, and outputs the acquired desired map information. Further, the map information generation unit generates route information in an area determined from the current location of the vehicle to a first distance and first map information in an area determined from the current location of the vehicle to a second distance shorter than the first distance.

### SUMMARY

The present disclosure provides a spatial information output apparatus, a spatial information output method and a spatial information output program, capable of suppressing an increase in pieces of unnecessary information in a map information to be outputted.

A first aspect of the present disclosure is a spatial information output apparatus provided with an acquiring unit that acquires map data including a location of an own vehicle and a type of a road; and an output unit that extracts a reduced map data from an extraction area of the map data, and outputs the reduced map data of the extraction area, the extraction area being from the location of the own vehicle to a setting distance in the map data, in which the output unit is configured to change the setting distance based on the type of the road on which the own vehicle is located.

### BRIEF DESCRIPTION OF THE DRAWINGS

The above-described configurations, features and advantages of the present disclosure will be clarified further by the following detailed description with reference to the accompanying drawings. The drawings are:

FIG. 1 is a block diagram showing an overall configuration of a vehicle system in which a spatial information output apparatus according to embodiments of the present disclosure;

FIG. 2 is a diagram showing map data;

FIG. 3 is a flowchart showing a procedure performed by a location determination unit of the spatial information output apparatus;

FIG. 4 is a flowchart showing a procedure of a spatial information output unit of the spatial information output apparatus;

FIG. 5 is a diagram showing a procedure of a spatial information output unit in the case where the vehicle location is on an expressway;

FIG. 6 is a diagram showing a procedure of the spatial information output unit in the case where the vehicle location is on a national road;

FIG. 7 is a diagram showing a procedure of the spatial information output unit in the case where the vehicle travels on the ordinary road;

FIG. 8 is a sub-flowchart showing a procedure of the spatial information output unit;

FIG. 9 is a diagram showing a procedure performed by the spatial information output unit in the case where the vehicle location is on the expressway;

FIG. 10 is a diagram showing a procedure of the spatial information output unit;

FIG. 11 is a diagram showing a procedure of the spatial information output unit;

FIG. 12 is a diagram showing a procedure of the spatial information output unit;

FIG. 13 is a diagram showing a procedure of the spatial information output unit;

FIG. 14 is a sub-flowchart showing a procedure of the spatial information output unit;

FIG. 15 is a diagram showing a procedure of the spatial information output unit in the case where the vehicle is on the national road;

FIG. 16 is a diagram showing a procedure of the spatial information output unit;

FIG. 17 is a diagram showing a procedure of the spatial information output unit;

FIG. 18 is a diagram showing a procedure of the spatial information output unit;

FIG. 19 is a diagram showing a procedure of the spatial information output unit;

FIG. 20 is a sub-flowchart showing a procedure of the spatial information output unit;

FIG. 21 is a diagram showing a procedure of the spatial information output unit in the case where the vehicle is on the ordinary road;

FIG. 22 is a diagram showing a procedure of the spatial information output unit;

FIG. 23 is a diagram showing a procedure of the spatial information output unit;

FIG. 24 is a diagram showing a procedure of the spatial information output unit;

FIG. 25 is a diagram showing a procedure of the spatial information output unit in a spatial information output unit according to other embodiments; and

FIG. 26 is a diagram showing a procedure of the spatial information output unit in a spatial information output unit according to other embodiments.

### DETAILED DESCRIPTION OF THE PREFERRED EMBODIMENTS

A patent literature, for example, JP-A-2019-184499 discloses a map information generation apparatus that generates map information used for automatic driving control of a vehicle. This map information generation apparatus is provided with a location acquiring unit, a route information acquiring unit, a map information acquiring unit and a map information generation unit. The location acquiring unit acquires a current location of a vehicle. The route information acquiring unit acquires route information indicating a scheduled traveling route from the current location of the vehicle to the destination. The map information acquiring unit acquires high-precision map information. The map information generation unit acquires desired map information from the high-precision map information acquired by the map information acquiring unit based on the current location of the vehicle and the route information, and outputs the acquired desired map information. Further, the map information generation unit generates route information in an area determined from the current location of the vehicle to a first distance and first map information in an area determined from the current location of the vehicle to a second distance shorter than the first distance.

Roads where the vehicle travels include expressways, national roads different from the expressway and ordinary roads different from the expressway and the national road. Considering information acquired from such various kinds of roads, the quantity of pieces of information acquired from the ordinary road is larger than those from the expressway and the national road. Further, the traveling speed of the vehicle traveling on the ordinary road is relatively lower than the traveling speed of the vehicle traveling on the express way and the national road. Hence, the quantity of pieces of information in a wide area of the ordinary road may be unnecessary. Hence, according to a map information generation apparatus disclosed by JP-A-2019-184499, in which the first map information is generated for an area determined from the current location of the vehicle to the second distance shorter than the first distance, unnecessary pieces information for the map information to be outputted may increase depending on types of road where the vehicle travels. Therefore, processing load of an automatic driving control which utilizes information generated by the map information generation apparatus disclosed by JP-A-2019-184499 may increase.

Hereinafter, with reference to the drawings, embodiments of the present disclosure will be described. For configurations mutually the same or equivalent configurations, the same reference signs are applied thereto and the explanation thereof will be omitted.

According to the spatial information output method and the spatial information output apparatus that executes the spatial information output program according to the present embodiment, unnecessary information in the map data to be outputted is prevented from increasing. Specifically, the spatial information output apparatus is used for a vehicle system. Firstly, the vehicle system will be described.

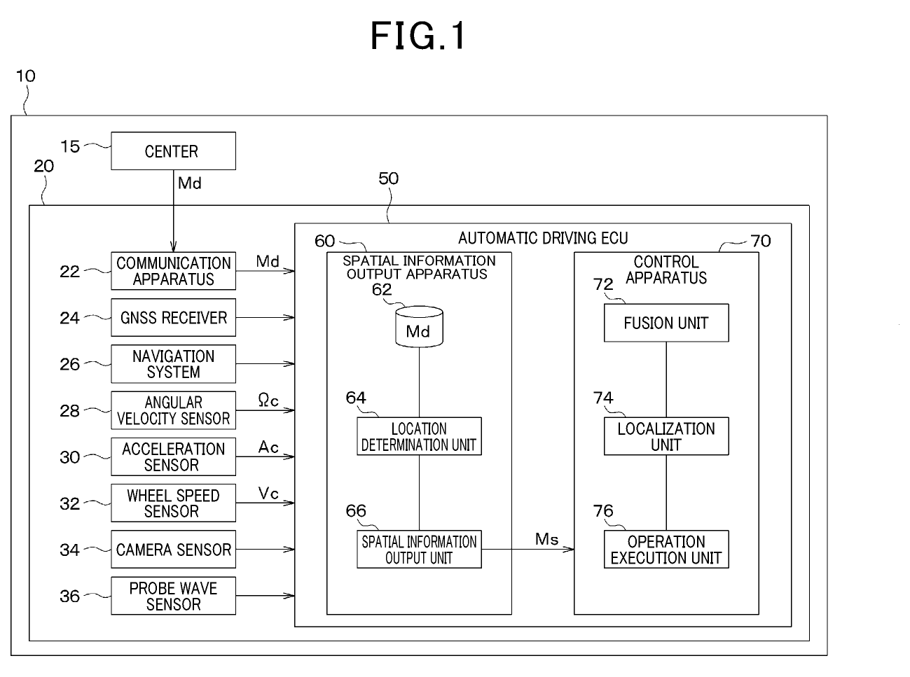

As shown in FIG. 1, the vehicle system 10 is provided with a center 15 and an own vehicle 20. The center 15 is like an institution or a facility. The center 15 includes map data Md.

The map data Md is a high-precision map and generated using NDS (i.e. Navigation Data Standard). NDS is a database format for a standardized car navigation system which is jointly-developed by an automobile manufacturer and a supplier.

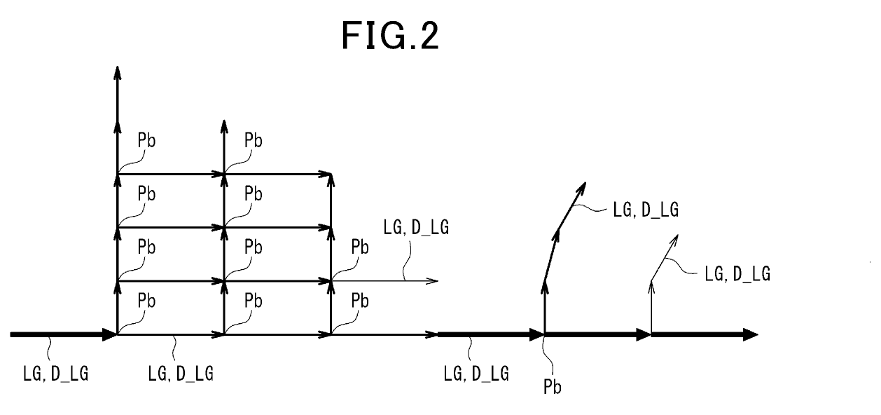

Further, the map data Md is, as shown in FIG. 2, a plurality of lane groups LG and branch points Pb and the like.

The lane group LG includes a vehicle traveling direction (not shown), a lane and the like. The vehicle traveling direction refers to a traveling direction for a vehicle, and a direction in which the vehicle traveling on the road should travel. The lane refers to a modeled traffic lane of a road. Moreover, the lane includes shape dots and the like indicating lane positions.

Further, the lane group LG includes a group direction D_LG and types of road. The group direction D_LG is a digitized direction of the lane group LG, corresponding to a vehicle traveling direction and a lane direction.

The type of road includes an expressway, a national road and an ordinary road. The expressway refers to a legal road, structurally measured for vehicles to travel safely and comfortably at high speed, among major roads connecting important regions which are politically, economically, and culturally significant, such as large cities, industrial cities, important harbors, airports and the like. In Japan, the expressway refers to a national expressway and a road designated strictly for motor vehicles. The national road is different from the expressway and constitutes a national major road network together with the expressways, satisfying prescribed legal requirements. The national road is constituted of a major road network built and managed by the country. The ordinary road is different from the expressway and the national road, and is referred to as a road excluding the expressway and the national road. In Japan, the ordinary roads are prefectural and municipal roads. In FIG. 2, the lane group LF of which the road type is an expressway is indicated by a bold line. When the road type is a national road, the lane group LF is indicated by a line thinner than that of the expressway. When the road type is an ordinary road, the lane group LF is indicated by a line thinner than that of the national road. Also, with subsequent drawings, the road type of the lane group LG is indicated by lines having similar width of the above-described lines. Note that the expressway, the national road and the ordinary road correspond to first road, second road and third road, respectively.

The branch point Pb is a point at which one lane group LG is branched into a plurality of lane groups LG.

Referring back to FIG. 1, the own vehicle 20 is provided with a driving force by an engine or a motor, thereby traveling on the road. The own vehicle 20 is provided with a communication apparatus 22, a GNSS receiver 24, a navigation system 26, an angular velocity sensor 28, an acceleration sensor 30, a wheel speed sensor 32, a camera sensor 34, a probe wave sensor 36 and an automatic driving ECU 50.

The communication apparatus 22 includes an interface for communicating with a center 15 and an automatic driving ECU 50 which will be described later.

The GNSS receiver 24 receives signals from a plurality of positioning satellites which are not shown. Moreover, the GNSS receiver 24 estimates the location of the own vehicle 20 based on the received signals. Further, the GNSS receiver 24 transmits a signal depending on the estimated location of the own vehicle 20 to the automatic driving ECU 50 which will be described later. The positioning satellites used for the GNSS receiver 24 include, for example, GPS satellites, GLONASS satellites, Galileo satellites, quasi-zenith satellites and the like.

The navigation system 26 performs a route guidance for the own vehicle 20 to the destination. When the navigation system 26 performs a route guidance to the destination, the navigation system 26 transmits information related to the route guidance to the automatic driving ECU 50 which will be described later.

The angular velocity sensor 28 detects angular velocity Ωc of the own vehicle 20. Further, the angular velocity sensor 28 transmits a signal depending on the detected angular velocity Ωc to the automatic driving ECU 50 which will be described later. Note that the angular velocity Ωc includes a roll angular velocity, a pitch angle velocity and a yaw angle velocity.

The acceleration sensor 30 detects an acceleration Ac of the own vehicle 20. Also, the acceleration sensor 30 transmits signals depending on the detected acceleration Ac to the automatic driving ECU 50 which will be described later. Note that the acceleration Ac includes accelerations in the longitudinal direction, the left-right direction and the vertical direction of the own vehicle 20.

The wheel speed sensor 32 detects a rotation speed of the wheels of the own vehicle 20. Thus, the wheel sensor 32 detects the vehicle speed Vc. Further, the wheel speed sensor 32 transmits the signals depending on the detected vehicle speed Vc to the automatic driving ECU 50 (described later). The vehicle speed Vc is a traveling speed of the own vehicle 20.

The camera sensor 34 is provided with a camera and an image processing unit which are not shown. The camera is configured as a monocular camera or a stereo camera, capturing image in the vicinity of the own vehicle 20. The image processing unit is configured to compare an object in an image captured by the camera with a template (reference) image of objects prepared in advance, thereby identifying type of the object in the image. Further, the image processing unit converts a coordinate system from the image coordinate system to the vehicle coordinate system based on the orientation of the camera and the focal distance thereof, thereby calculating the relative location of the object in the image captured by the camera with respective to the own vehicle 20. Moreover, the image processing unit transmits the identification information of objects together with signals indicating the calculated relative location to the automatic driving ECU 50.

The probe wave sensor 36 transmits probe waves such as milli-meter wave radar, sonar and infrared light to objects in the vicinity of the own vehicle 20. Also, the probe wave sensor 36 receives probe waves reflected at the objects in the vicinity of the own vehicle 20. Moreover, the probe wave sensor 36 identifies type of the objects based on the information obtained from the probe waves and calculates the relative location of the objects with respect to the own vehicle 20. Further, the probe wave sensor 36 transmits the identification information of the objects and the signal depending on the calculated relative location to the automatic driving ECU 50.

The automatic driving ECU 50 is mainly configured of a microprocessor, including CPU, ROM, flash memory, RAM, I/O, a communication interface and a bus line which connects therebetween. Further, the automatic driving ECU 50 is provided with a spatial information output apparatus 60 and a control apparatus 70.

The spatial information output apparatus 60 is provided with a map storing unit 62, a location determination unit 64 and a spatial information output unit 66 as functional blocks.

The map storing unit 62 acquires map data Md from the center 15 via the communication apparatus 22. Also, the map storing unit 62 stores the map data Md acquired from the center 15.

The location determination unit 64 executes programs stored in the ROM included in the automatic driving ECU 50. Thus, the location determination unit 64 acquires the map data Md from the map storing unit 62. Further, the location determination unit 64 acquires signals from the GNSS receiver 24, the angular velocity sensor 28, the acceleration sensor 30 and the wheel speed sensor 32. Moreover, the location determination unit 64 determines, based on the acquired map data Md and the signals, current location of the own vehicle 20 on the map data Md. Thus, the location determination unit 64 determines the traffic lane on the map data Md where the own vehicle travels. Further, the location determination unit 64 outputs the map data Md with which the current location of the own vehicle 20 is determined to the spatial information output unit 66 which will be described later. Note that detailed processes of the location determination unit 64 will be described later.

The spatial information output unit 66 executes programs stored in the ROM of the automatic driving ECU 50. Thus, the spatial information output unit 66 acquires the map data Md in which the current location of the own vehicle 20 is determined, from the location determination unit 64. Also, the spatial information output unit 66 executes processes for setting and changing a setting distance Ls, based on the type of the road where the own vehicle 20 is located. Moreover, the spatial information output unit 66 extracts, among the above-described acquired map data Md, a map data in an area from the current location of the own vehicle 20 to the setting distance Ls. Further, the map information output unit 66 outputs the extracted map data Md in the extracted area as the spatial information Ms to the control apparatus 70 (described later). Note that detailed processes to be executed by the spatial information output unit 66 will be described later.

The control apparatus 70 is provided with a fusion unit 72, a localization unit 74 and an operation execution unit 76 as functional blocks.

The fusion unit 72 executes programs stored in the ROM of the automatic driving ECU 50. Thus, the fusion unit 72 acquires the identification information and the relative location of the object from the camera sensor 34 and the probe wave sensor 36. Further, the fusion unit 72 acquires spatial information Ms from the spatial information output unit 66. Moreover, the fusion unit 72 causes the information acquired from the camera sensor 34 and the probe wave sensor 36 and the spatial information Ms acquired from the spatial information output unit 66 to be combined. For example, the fusion unit 72 causes the type and location of the object detected by the camera sensor 34 and the probe wave sensor 36 to be reflected in the map data Md included in the spatial information Ms. Further, the fusion unit 72 outputs the combined spatial information Ms to the localization unit 74.

The localization unit 74 executes programs stored in the ROM of the automatic driving ECU 50. Thus, the localization unit 74 acquires the spatial information Ms combined by the fusion unit 72. Also, the localization unit 74 determines the current location of the own vehicle 20 on the space information Ms combined by the fusion unit 72. Thus, the localization unit 74 determines a traffic lane where the own vehicle 20 travels on the spatial information Ms. Further, the localization unit 74 outputs the determined spatial information Ms to the operation execution unit 76.

The operation execution unit 76 executes programs stored in the ROM of the automatic driving ECU 50. Thus, the operation execution unit 76 acquires signals from the angular velocity sensor 28, the acceleration sensor 30 and the wheel speed sensor 32. Also, the operation execution unit 76 acquires the spatial information Ms combined by the fusion unit 72, in which the current location of the own vehicle 20 is determined, from the localization unit 74. Further, the operation execution unit 76 utilizes these acquired signals and the spatial information Ms to automatically control the behavior of the own vehicle 20. With this control, for example, the operation execution unit 76 performs acceleration, deceleration, stop, start, and left-right turn operations, thereby performing the automatic driving of the own vehicle 20. Hence, the own vehicle 20 travels on the road without manual operation of the own vehicle 20 performed by the driver. Note that the operation execution unit 76 may not be limited to perform automatic driving of the own vehicle 20, but may perform a driving assist operation that assists operation by the driver of the own vehicle 20.

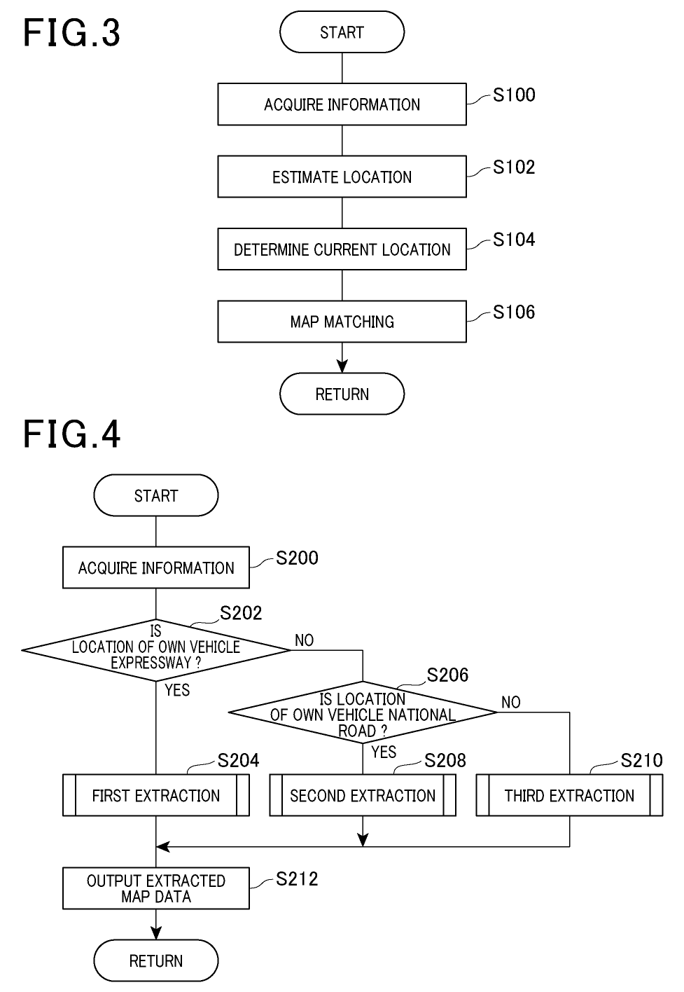

The vehicle system 10 including the spatial information output apparatus 60 is configured as descried above. Next, with reference to the flowchart shown in FIG. 3, processes executed by the location determination unit 64 will be described. The programs of the location determination unit 64 are executed, for example, when the power source of the own vehicle 20 is turned ON. Further, an operation period where series of processes are executed from when the process at step S100 is executed to when the process returns to the step S100 is referred to as a processing period of the location determination unit 64.

At step S100, the location determination unit 64 acquires various information. Specifically, the location determination unit 64 acquires the map data Md from the map storing unit 62. Further, the location determination unit 64 acquires location of the own vehicle 20 from the GNSS receiver 24. Further, the location determination unit 64 acquires an angular velocity Ωc from the angular velocity sensor 28. Further, the location determination unit 64 acquires the acceleration Ac from the acceleration sensor 30. Moreover, the location determination unit 64 acquires the vehicle speed Vc from the wheel sensor 32.

At step S102 subsequent to step S100, the location determination unit 64 calculates a relative locus based on the current location determined at step S104 in the previous processing period, the angular velocity Ωc and the acceleration Ac acquired at step S100. The origin of the relative locus is defined as the current location determined at step S104 (described later) in the previous processing period. Further, the location determination unit 64 estimates the location of the own vehicle 20 in accordance with the calculated relative locus. Note that the location determination unit 64 may utilize the vehicle speed Vc acquired at step S100 instead of utilizing the angular velocity Ωc and the acceleration Ac acquired at step S100, to calculate the relative locus.

At step S104 subsequent to step S102, the location determination unit 64 uses the location of the own vehicle 20 acquired from the GNSS receiver 24 at step S100, the location of the own vehicle 20 calculated in accordance with the relative locus estimated at step S102, and a composite navigation system. Thus, the location determination unit 64 determines the current location using the composite navigation system. For example, the location determination unit 64 determines whether these locations can be utilized or not based on the accuracies of the location detected by the GNSS receiver 24 and the location of the own vehicle 20 using the relative locus. Further, the location determination unit 64 determines weighting factor of these locations based on these accuracies. The location determination unit 64 corrects either the location using the GNSS receiver 24 or the location using the relative locus, based on the determined weighting factor. Thus, the location determination unit 64 determines the current location using the composite navigation system.

At step S106 subsequent to step S104, the location determination unit 64 performs a map matching. Specifically, the location determination unit 64 makes the map data Md acquired at step S100 match with the relative locus of which the end point is the current location determined at step S104. Thus, the location determination unit 64 determines the current location of the own vehicle 20 on the map data Md. Further, the location determination unit 64 determines the traffic lane where the own vehicle 20 travels on the map data Md. Moreover, the location determination unit 64 outputs the map data Md in which the current location of the own vehicle 20 is determined to the spatial information output unit 66. Thereafter, the process of the location determination unit 64 returns to step S100.

The location determination unit 64 executes processes as described above. Next, with reference to a flowchart shown in FIG. 4, processes executed by the spatial information output unit 66 will be described. Note that programs to be executed by the spatial information output unit 66 are executed, for example, when the power source of the own vehicle 20 is ON and a route guidance of the navigation system 26 is not performed.

At step S200, the spatial information output unit 66 acquires information. Specifically, the spatial information output unit 66 acquires the map data Md in which the current location of the own vehicle 20 is determined, from the location determination unit 64. Thus, the spatial information output unit 66 acquires the map data Md including the location of the own vehicle 20 and the type of the road.

At step S202 subsequent to step S200, the spatial information output unit 66 determines whether the location of the own vehicle 20 indicates that it is on an expressway based on the map data Md acquired at step S200.

Then, when the location of the own vehicle 20 is on the expressway, the processes of the spatial information output unit 66 proceeds to step S204. Further, when the location of the own vehicle 20 is not on an expressway, that is, the location of the own vehicle 20 is either on a national road or an ordinary road, the process of the spatial information output unit 66 proceeds to step S206.

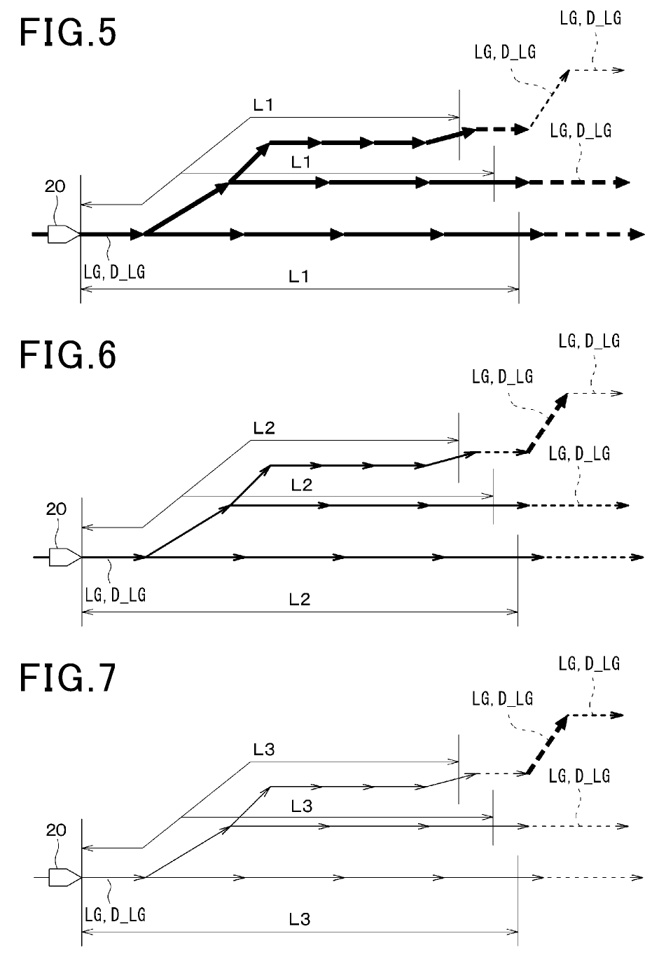

At step S204 subsequent to step S202, the spatial information output unit 66 performs a first extraction for the map data Md acquired at step S200. In the first extraction, the spatial information output unit 66 sets the setting distance Ls to be a first distance L1. Further, as shown in FIG. 5, the spatial information output unit 66 extracts a first area data in a first area from the map data Md acquired at step S200. The first area refers to an area from the location of the own vehicle 20 to the first distance L1. Note that the first distance L1 is set using an experience or a simulation such that unnecessary data is reduced. The first distance L1 is 6000 meters, for example. Further, in FIG. 5, lane group LG outside the first area is indicated by a dotted line.

Further, in the first extraction process, the spatial information output unit 66 may change the setting distance LS from the first distance L1, thereby changing the extraction area. A detailed process of the first extraction will be described later. After performing the first extraction process by the spatial information output unit 66, the process of the spatial information output unit 66 proceeds to step S212.

At step S206 subsequent to step S202 shown in a flowchart of FIG. 4, the spatial information output unit 66 determines, based on the map data Md acquired at step S200, whether the location of the own vehicle 20 is a national road.

Then, when the location of the own vehicle 20 is a national road, the process of the spatial information output unit 66 proceeds to step S208. Further, when the location of the own vehicle 20 is not the national road, that is, the location of the own vehicle 20 is an ordinary road, the process of the spatial information output unit 66 proceeds to step S210.

At step S208 subsequent to step S206, the spatial information output unit 66 performs a second extraction for the map data Md acquired at step S200. In the second extraction, the spatial information output unit 66 sets the setting distance Ls to be the second distance L2. Further, as shown in FIG. 6, the spatial information output unit 66 extracts a second area data in a second area from the map data Md acquired at step S200. The second area refers to an area from the location of the own vehicle 20 to the second distance L2. Note that the second distance L2 is shorter than the first distance L1, and set using an experience or a simulation such that unnecessary data is reduced. The second distance L2 is 3000 meters for example. Further, in FIG. 6, lane group LG outside the second area is indicated by a dotted line.

Further, in the second extraction, the spatial information output unit 66 may change the setting distance Ls from the second distance L2, thereby changing the extraction area. A detailed process of the second extraction will be described later. After performing the second extraction process by the spatial information output unit 66, the process of the spatial information output unit 66 proceeds to step S212.

At step S210 subsequent to step S206 in the flowchart shown in FIG. 4, the spatial information output unit 66 performs a third extraction for the map data Md acquired at step S200. In the third extraction, the spatial information output unit 66 sets the setting distance Ls to be the third distance L3. Further, as shown in FIG. 7, the spatial information output unit 66 extracts a third area data in a third area from the map data Md acquired at step S200. The third area refers to an area from the location of the own vehicle 20 to the third distance L3. Note that the third distance L3 is shorter than the second distance L2, and set using an experience or a simulation such that unnecessary data is reduced. The third distance L3 is 500 meters for example. Further, in FIG. 7, lane group LG outside the third area is indicated by a dotted line.

Further, in the third extraction, the spatial information output unit 66 may change the setting distance Ls to be the third distance L3, thereby changing the extraction area. A detailed process of the third extraction will be described later. After performing the third extraction process by the spatial information output unit 66, the process of the spatial information output unit 66 proceeds to step S212.

At step S212 in a flowchart shown in FIG. 4, the spatial information output unit 66 outputs the map data Md extracted in the first extraction at step S204, the second extraction at step S208 and the third extraction at step S210, to the automatic driving ECU 50 as the spatial information Ms. The fusion unit causes the spatial information Ms outputted to the automatic driving ECU 50 to be combined with the information acquired from the camera sensor 34 and the probe wave sensor 36. For the spatial information Ms which is combined with the information acquired by the camera sensor 34 and the probe wave sensor 36 in the fusion unit 72, the localization unit 74 determines the current location of the own vehicle 20. The spatial information Ms, where the fusion unit 72 causes the information acquired from the camera sensor 34 and the probe wave sensor 36 to be combined therewith and the localization unit 74 determines the current location of the own vehicle 20, is used for the operation execution unit 76 to perform an automatic control of the behavior of the own vehicle 20. Thereafter, the process of the spatial information output unit 66 returns to step S200.

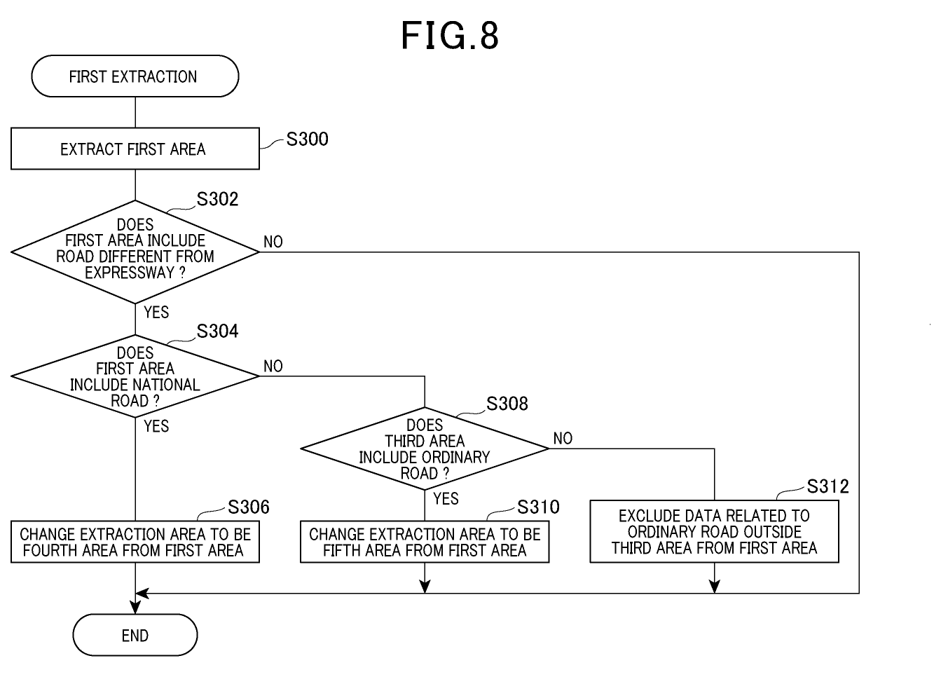

As described above, the spatial information output unit 66 executes the above-described processes. Next, with reference to a sub-flowchart shown in FIG. 8, a first extraction process executed by the first extraction process will be described.

At step S300 in the sub-flowchart of FIG. 8 corresponding to the first extraction process at step S204 subsequent to step S202 shown in the flowchart of FIG. 4, the spatial information output unit 66 sets the setting distance Ls to be the first distance L1. Also, the spatial information output unit 66 extracts the first area data from the map data Md acquired at step S200.

At step S302 subsequent to step S300, the spatial information output unit 66 determines whether the first area data extracted at step S300 includes a road of which the road type is different from that of the expressway.

Then, in the case where the first area data does not include a road of which the road type is different from that of the expressway, the first extraction process of the spatial information output unit 66 is terminated and the process proceeds to step S212. Further, in the case where the first area data includes a road of which the road type is different from that of the expressway, the process of the spatial information output unit 66 proceeds to step S304.

At step S304 subsequent to step S302, the spatial information output unit 66 determines whether the first area data extracted at step S300 includes a national road.

Then, when the first area data does not include a national road, the process of the spatial information output unit 66 proceeds to step S308. Further, when the first area data includes a national road, the process of the spatial information output unit 66 proceeds to step S306.

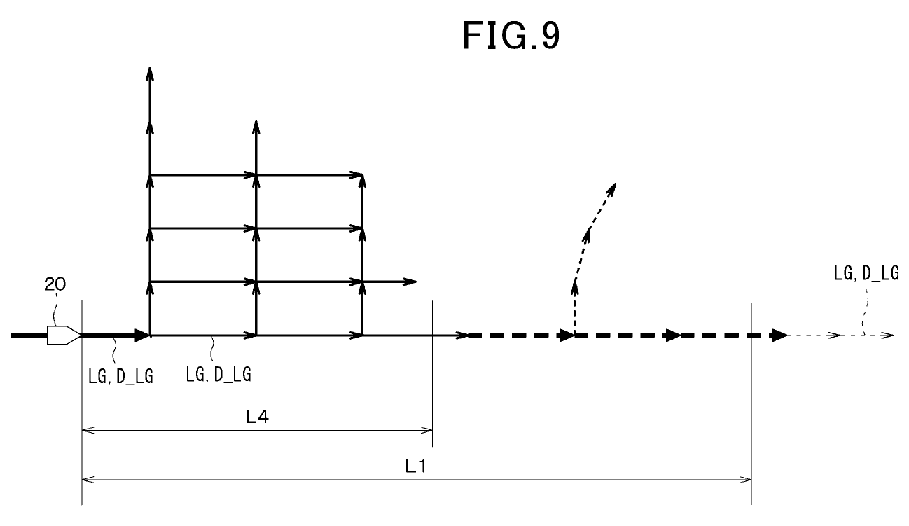

At step S306 subsequent to step S304, since the first area data includes a national road, compared to a case where only the expressway is included in the first area data, information quantity is large. Hence, as shown in FIG. 9, the spatial information output unit 66 changes the setting distance Ls to be the fourth distance L4 from the first distance L1. Moreover, the spatial information output unit 66 changes the extraction area to be the fourth area from the first area. Thus, the area of the map data Md becomes smaller. Hence, an increase in the quantity of unnecessary information of the map data Md to be outputted can be avoided. Thereafter, the process of the spatial information output unit 66 proceeds to step S212. Note that the fourth distance L4 is longer than or equal to the second distance L2 and shorter than the first distance L1. The fourth distance L4 is the same as the second distance L2, for example, 3000 meters. The fourth area refers to an area from the location of the own vehicle 20 to the fourth distance L4. In FIG. 9, lane group LG outside the fourth area is indicated by a dotted line.

At step S308 subsequent to step S304 in the sub-flowchart shown in FIG. 8, since a road different from the expressway is included in the first area data and a national road is not included in the first area data, an ordinary road is included. Then, the spatial information output unit 66 determines whether the third area data includes an ordinary road.

Then, when the third area data does not include an ordinary road, the process of the spatial information output unit 66 proceeds to step S312. Further, when the third area data includes an ordinary road, the spatial information output unit 66 proceeds to step S310.

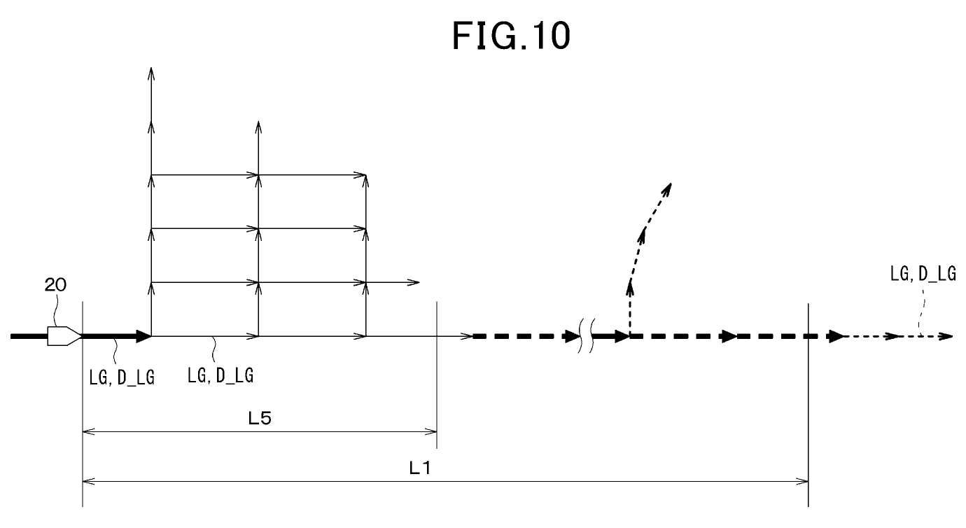

At step S310 subsequent to step S308, since the third area data includes an ordinary road, compared to a case where only the expressway is included in the first area data, information quantity is large. Hence, as shown in FIG. 10, the spatial information output unit 66 changes the setting distance Ls to be the fifth distance L5 from the first distance L1. Moreover, the spatial information output unit 66 changes the extraction area to be the fifth area from the first area. Thus, the area of the map data Md becomes smaller. Hence, an increase in the quantity of unnecessary information of the map data Md to be outputted can be avoided. Note that the fifth distance L5 is longer than or equal to the third distance L3 and shorter than the second distance L2. The fifth distance L5 is the same as the third distance L3, for example, 500 meters. The fifth area refers to an area from the location of the own vehicle 20 to the fifth distance L5. In FIG. 10, lane group LG outside the fourth area is indicated by a dotted line.

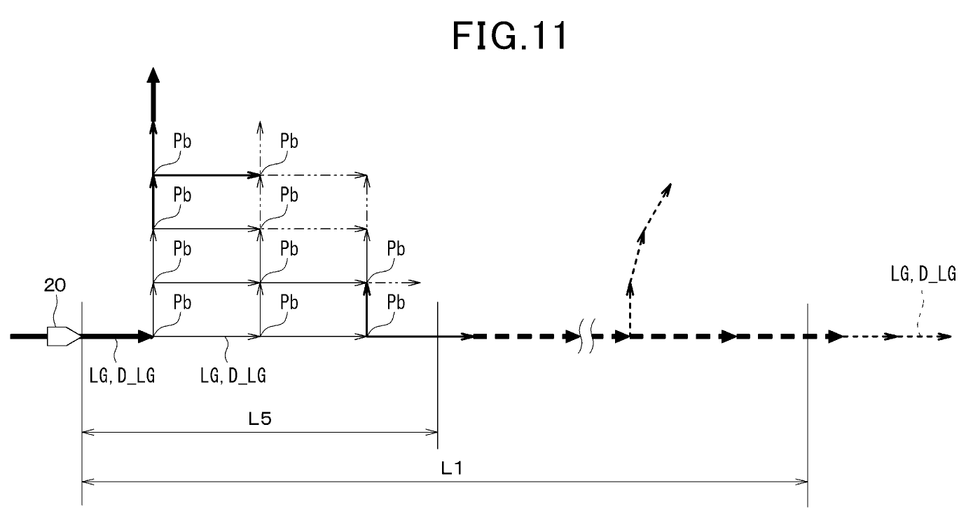

At this time, the spatial information output unit 66 may exclude data related to the ordinary road outside an area defined by a lane group LG of which the start point is the Nth branch point Pb from the location of the own vehicle 20 to the end point thereof. Note that N is a natural number, for example, 3. In FIG. 11, the excluded lane group LG is indicated by a two-dot chain line.

Then, after the spatial information output unit 66 executes the process of step S310, the process of the spatial information output unit 66 proceeds to step S212.

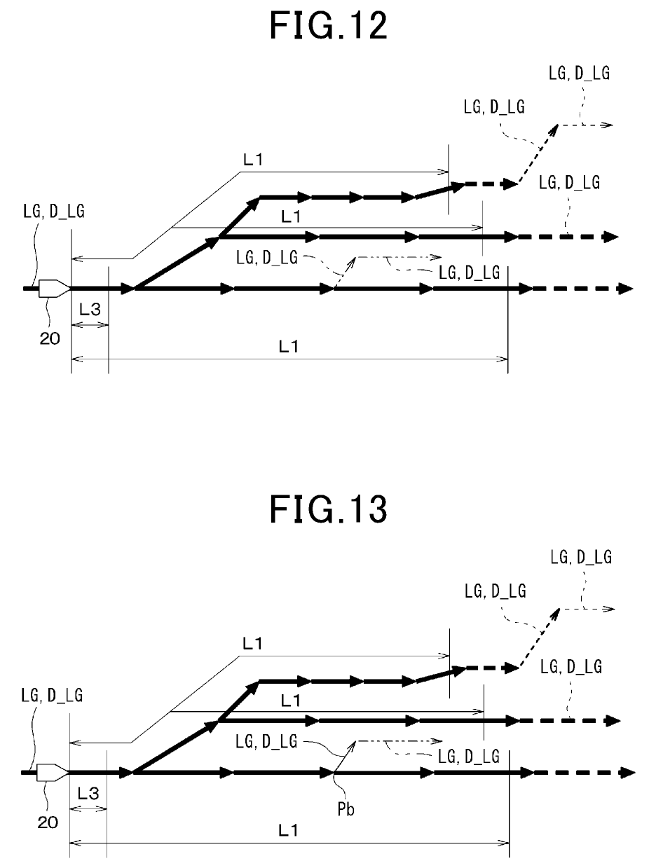

At step S312 subsequent to step S308 in the sub-flowchart shown in FIG. 8, since an ordinary road is included in the first area data but is not included in the third area data, an ordinary road is outside the third area. The ordinary road outside the third area is located relatively away from the own vehicle 20. Hence, data related to the ordinary road may be unnecessary. Therefore, as shown in FIG. 12, the spatial information output unit 66 excludes, from the first area data, data related to the ordinary road outside the third area. Thus, an increase in the quantity of unnecessary information of the map data Md to be outputted can be avoided. In FIG. 12, the excluded lane group LG is indicated by a two-dot chain line.

At this time, as shown in FIG. 13, the spatial information output unit 66 may not exclude but extract lane group LG of which the start point is a branch Pb, among data related to the ordinary road outside the third area. In FIG. 13, the excluded lane group LG is indicated by a two-dot chain line.

Then, after the spatial information output unit 66 executes the process of step S312, the process of the spatial information output unit 66 proceeds to step S212.

As described above, the spatial information output unit 66 executes a first extraction process. Next, the second extraction process executed by the spatial information output unit 66 will be described.

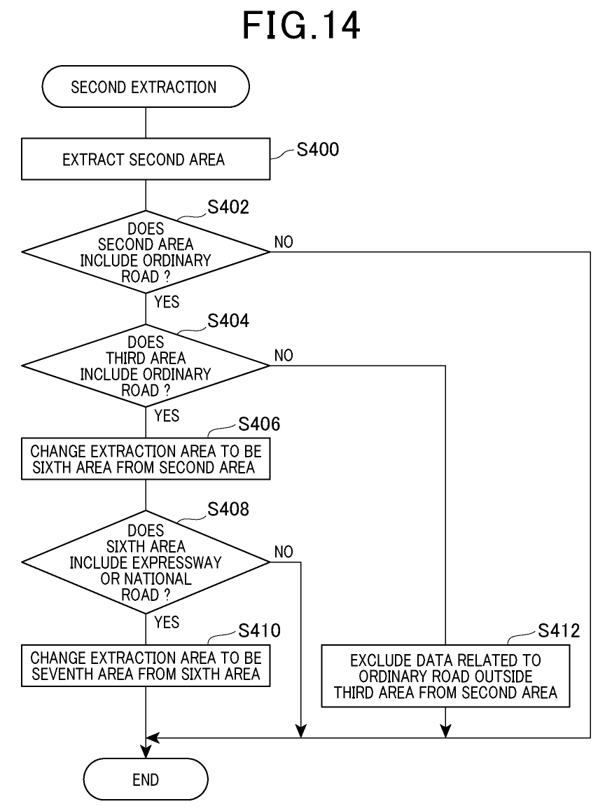

At step S400 in the sub-flowchart shown in FIG. 14 corresponding to the second extraction process at step S208 subsequent to step S206 of the flowchart shown in FIG. 4, the spatial information output unit 66 sets the setting distance Ls to be the second distance L2. Further, the spatial information output unit 66 acquires the second area data from the map data Md acquired at step S200.

At step S402 subsequent to step S400, the spatial information output unit 66 determines whether the second area data extracted at step S400 includes an ordinary road.

Then, in the case where an ordinary road is not included in the second area data, the spatial information output unit 66 terminates the second extraction process and the process proceeds to step S212. Moreover, when the second area data includes the ordinary road, the process of the spatial information output unit 66 proceeds to step S404.

At step S404 subsequent to step S403, the spatial information output unit 66 determines whether the third area data includes an ordinary road.

Then, when the third area data does not include an ordinary road, the process of the spatial information output unit 66 proceeds to step S412. Moreover, when the third area data includes an ordinary road, the process of the spatial information output unit 66 proceeds to step S406.

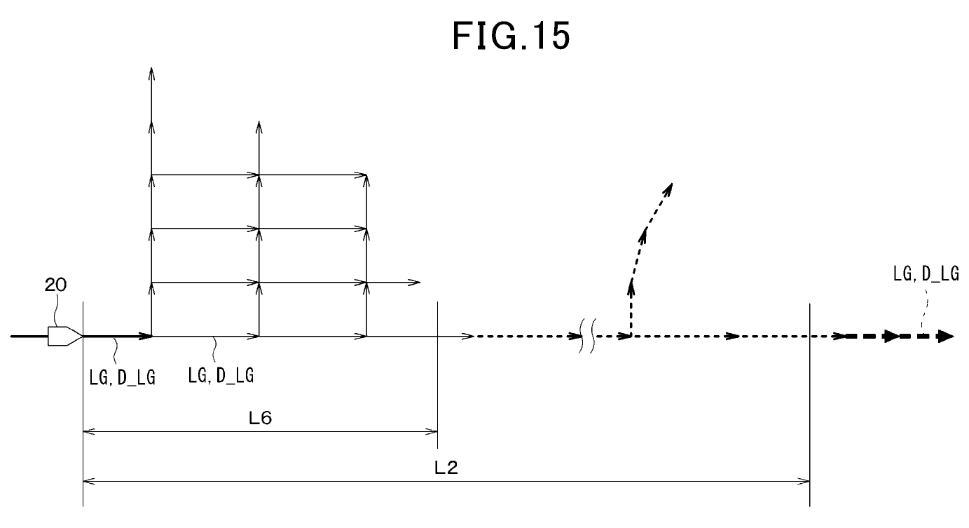

At step S406 subsequent to step S404, since the third area includes an ordinary road, compared to a case where only the national road is included in the second area data, information quantity is large. Hence, as shown in FIG. 15, the spatial information output unit 66 changes the setting distance Ls to be a sixth distance L6 from the second distance L2. Moreover, the spatial information output unit 66 changes the extraction area to be a sixth area from the second area. Thus, an area of the map data Md to be outputted becomes smaller. Hence, an increase in the quantity of unnecessary information of the map data Md to be outputted can be avoided. Note that the sixth distance L6 refers to a distance longer than or equal to the third distance L3 and shorter than the second distance L2. The sixth distance L6 is the same as the third distance L3 and the fifth distance L5 for example, 500 meters. The sixth area refers to an area from the location of the own vehicle 20 to the sixth distance L6.

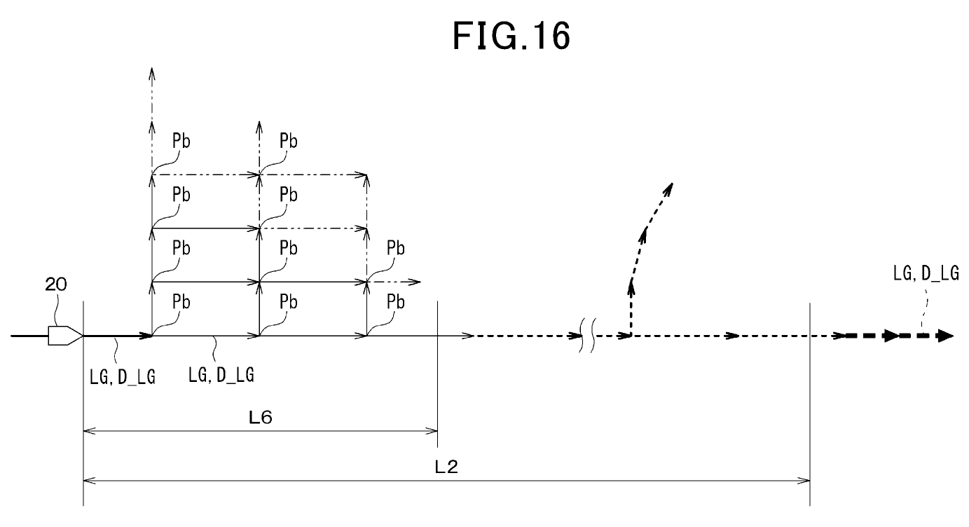

Then, as shown in FIG. 16, the spatial information output unit 66 may exclude data related to the ordinary road outside an area defined by a lane group LG of which the start point is the Nth branch point Pb from the location of the own vehicle 20 to the end point thereof. Note that N is a natural number, for example, 3. In FIG. 16, the excluded lane group LG is indicated by a two-dot chain line.

At step S408 subsequent to step S406 in the sub-flowchart shown in FIG. 14, the spatial information output unit 66 determines whether the sixth area data extracted at step S406 includes an expressway or a national road.

Then, when the sixth area data does not include an expressway or a national road, the spatial information output unit 66 terminates the second extraction process and the process proceeds to step S212. Further, when the sixth area data includes an expressway or an ordinary road, the process of the spatial information output unit 66 proceeds to step S410.

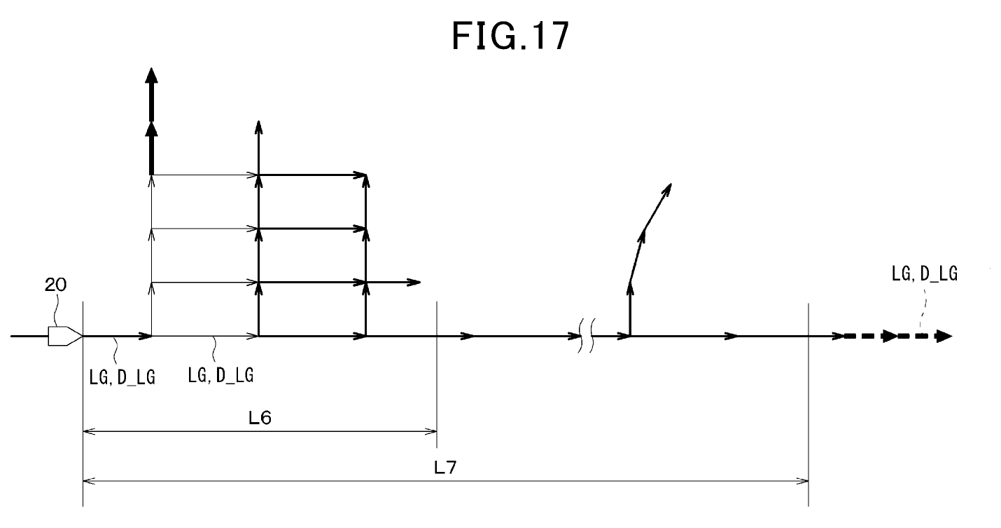

At step S410 subsequent to step S408, since the sixth area includes an expressway or a national road, compared to a case where only the ordinary road is included in the sixth area, information quantity may be small. Thus, even when information is added, the information quantity is unlikely to be excessively large. Hence, the spatial information output unit 66 changes the setting distance Ls to be the seventh distance L7 from the sixth distance L6. Further, as shown in FIG. 17, the spatial information output unit 66 changes the extraction area to be the seventh area from the sixth area. Thus, the quantity of the information included in the map data MD to be outputted can be prevented from being insufficient. Thereafter, the process of the spatial information output unit 66 proceeds to step S212. Note that the seventh distance L7 is longer than or equal to the second distance L2 and shorter than the first distance L1. The seventh distance L7 is the same as the second distance L2 and the fourth distance L4, for example, 3000 meters. The seventh area L7 refers to an area from the location of the own vehicle 20 to the seventh distance L7. In FIG. 17, lane group LG outside the seventh area is indicated by a dotted line.

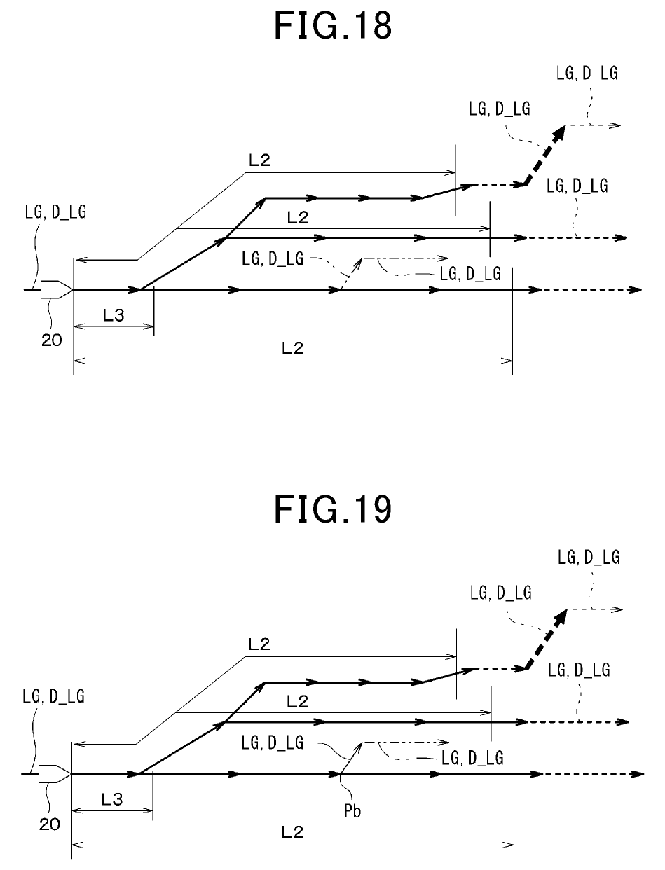

At step S412 subsequent to step S404 in the sub-flowchart shown in FIG. 14, since an ordinary road is included in the second area data but is not included in the third area data, the ordinary road is outside the third area. The ordinary road outside the third area is located relatively away from the own vehicle 20. Hence, data related to the ordinary road may be unnecessary. Therefore, as shown in FIG. 18, the spatial information output unit 66 excludes, from the second area data, data related to the ordinary road outside the third area. Thus, an increase in the quantity of unnecessary information of the map data Md to be outputted can be avoided. In FIG. 18, the excluded lane group LG is indicated by a two-dot chain line.

At this time, as shown in FIG. 19, the spatial information output unit 66 may extract lane group LG of which the start point is the branch point Pb among data related to the ordinary road outside the third area without excluding them. Note that excluded lane group is indicated by a two-dot chain line.

Then, after the spatial information output unit 66 executes the process of step S412, the process of the spatial information output unit 66 proceeds to step S212.

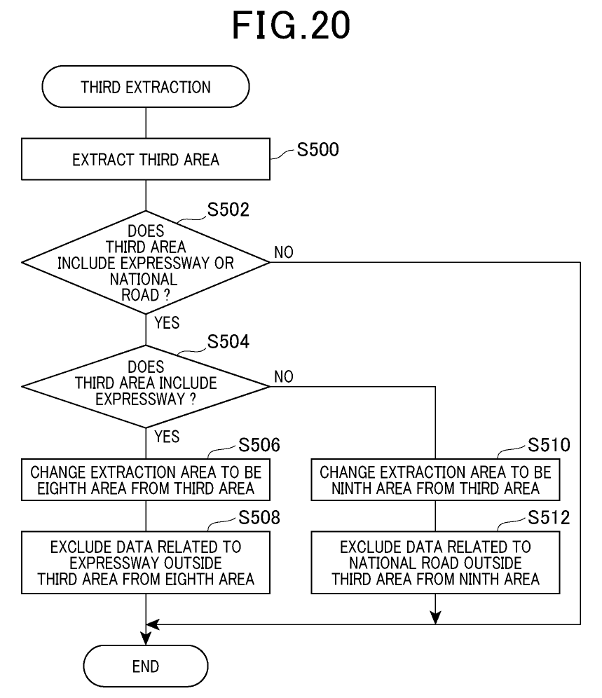

As described above, the spatial information output unit 66 executes the second extraction process. Next, with reference to a sub-flowchart shown in FIG. 20, a third extraction process executed by the spatial information output unit 66 will be described.

At step S500 in the sub-flowchart shown in FIG. 20 corresponding to the third extraction process at step S210 subsequent to step S206 of the flowchart shown in FIG. 4, the spatial information output unit 66 sets the setting distance Ls to be the third distance L3. Further, the spatial information output unit 66 acquires the third area data from the map data Md acquired at step S200.

At step S502 subsequent to step S500, the spatial information output unit 66 determines whether the third area data extracted at step S500 includes an expressway or a national road.

Then, when the third area data does not include an expressway or a national road, the third extraction process of the spatial information output unit 66 is terminated and the process proceeds to step S212. Moreover, when the third area data includes an expressway or a national road, the process of the spatial information output unit 66 proceeds to step S504.

At step S504 subsequent to step S502, the spatial information output unit 66 determines whether the third area data extracted at step S500 includes an expressway.

Then, when the third area data does not include an expressway, the process of the spatial information output unit 66 proceeds to step S510. Further, when the third area data includes an expressway, the process of the spatial information output unit proceeds to step S506.

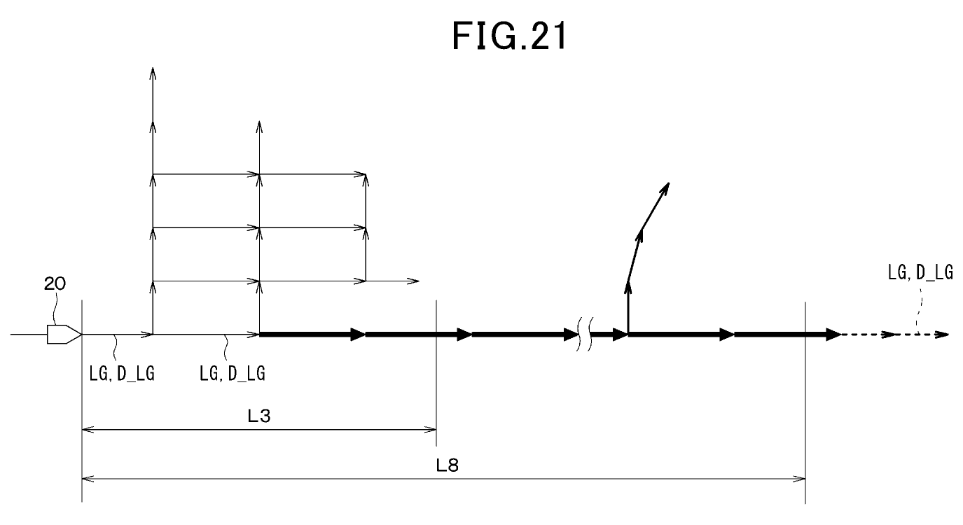

At step S506 subsequent to step S504, since the third area includes an expressway, compared to a case where only the ordinary road is included in the third area data, information quantity may be small. Thus, even when information is added, the information quantity is unlikely to be excessively large. Hence, as shown in FIG. 21, the spatial information output unit 66 changes the setting distance Ls to be the eighth distance L8 from the third distance L3. Further, the spatial information output unit 66 changes the extraction area to be the eighth area from the third area. Thus, the quantity of the information included in the map data MD to be outputted can be prevented from being insufficient. Note that the eighth distance L8 is longer than or equal to the second distance L2 and shorter than the first distance L1. The eighth distance L8 is the same as the second distance L2, the fourth distance L4 and the seventh distance L7, for example, 3000 meters. The eighth area L8 refers to an area from the location of the own vehicle 20 to the eighth distance L8. In FIG. 21, the lane group LG outside the eighth area is indicated by a dotted line.

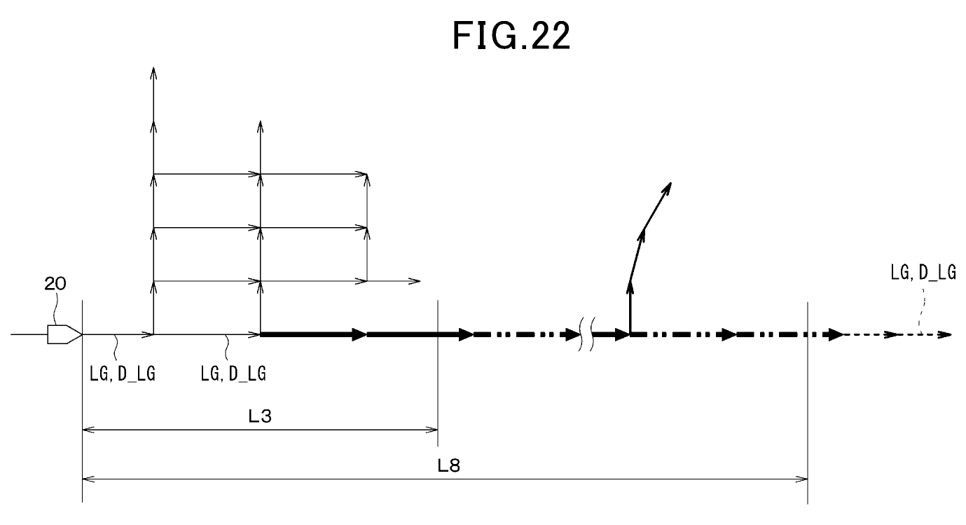

At step S508 subsequent to step S506 in the sub-flowchart shown in FIG. 20, when an expressway is included in the eighth area, since the expressway outside the third area is located relatively away from the own vehicle 20, data related to the expressway may be unnecessary. Hence, as shown in FIG. 22, the spatial information output unit 66 excludes, from the eighth area data, data related to the expressway outside the third area. Thus, an increase in the quantity of unnecessary information of the map data Md to be outputted can be avoided. Thereafter, the process of the spatial information output unit 66 proceeds to step S212. In FIG. 22, the excluded lane group LG is indicated by a two-dot chain line.

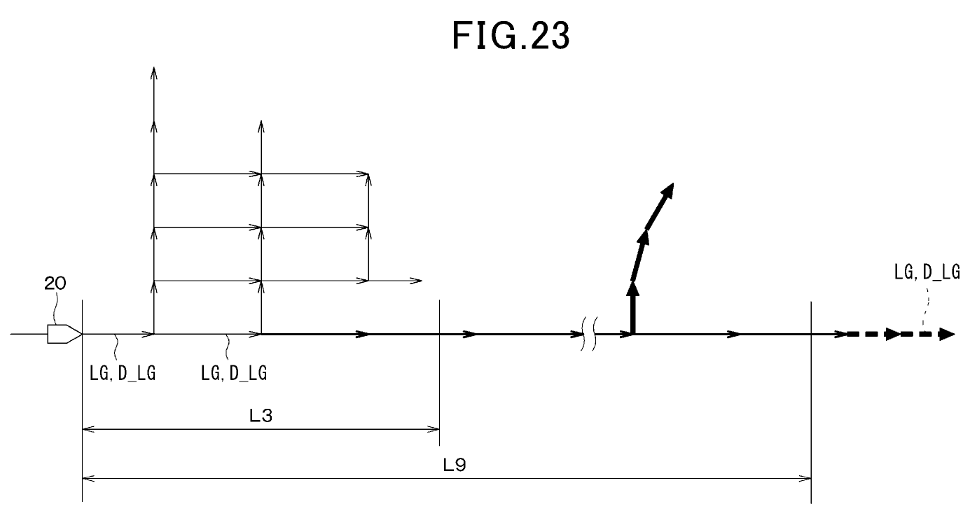

At step S510 subsequent to step S504 of the sub-flowchart shown in FIG. 20, since the third area includes a national road, compared to a case where only the ordinary road is included in the third area data, information quantity may be small. Thus, even when information is added, the information quantity is unlikely to be excessively large. Hence, as shown in FIG. 23, the spatial information output unit 66 changes the setting distance Ls to be the ninth distance L9 from the third distance L3. Further, the spatial information output unit 66 changes the extraction area to be the ninth area from the third area. Thus, the quantity of the information included in the map data MD to be outputted can be prevented from being insufficient. Note that the ninth distance L9 is longer than or equal to the second distance L2 and shorter than the first distance L1. The ninth distance L9 is the same as the second distance L2, the fourth distance L4, the seventh distance L7 and the eighth distance L8, for example, 3000 meters. The ninth area L9 refers to an area from the location of the own vehicle 20 to the ninth distance L9. In FIG. 23, the lane group LG outside the ninth area is indicated by a dotted line.

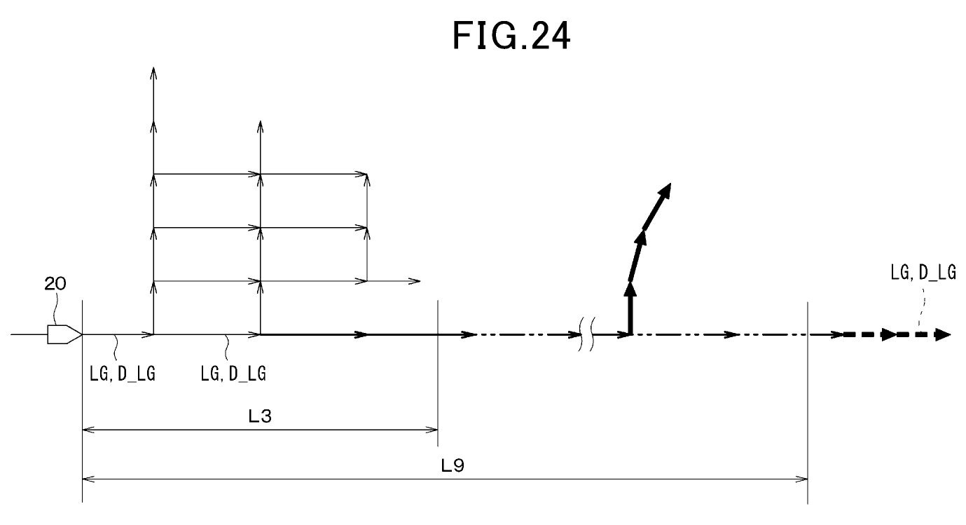

At step S512 subsequent to step S510, when a national road is included in the ninth area, since the national road outside the third area is located relatively away from the own vehicle 20, data related to the national road may be unnecessary. Hence, as shown in FIG. 24, the spatial information output unit 66 excludes, from the ninth area data, data related to the national road outside the third area. Thus, an increase in the quantity of unnecessary information of the map data Md to be outputted can be avoided. Thereafter, the process of the spatial information output unit 66 proceeds to step S212. In FIG. 24, the excluded lane group LG is indicated by a two-dot chain line.

As described above, the spatial information output unit 66 executes the third extraction process. Next, a configuration of the spatial information output apparatus 60 for preventing unnecessary information in the map data to be outputted from increasing will be described.

The spatial information output unit 66 of the spatial information output apparatus 60 serves as an acquiring unit that acquires the map data Md including the location of the own vehicle 20 and the type of the road. Further, the spatial information output unit 66 serves as an output unit that extracts data in an area from the location of the own vehicle 20 to the setting distance Ls and outputs the map data Md (reduced map data) in the extracted area data. Moreover, the spatial information output unit 66 changes the setting distance Ls based on the type of the road where the own vehicle 20 is located.

Thus, map data Md (reduced map data) in an area suitable for the type of road is extracted among the map data Md. Hence, the map data Md having an appropriate information quantity is extracted. Accordingly, an increase in the quantity of unnecessary information of the map data Md to be outputted can be avoided.

### Other Embodiments

The present disclosure is not limited to the above-described embodiments, and the above-described embodiments may be appropriately modified. Moreover, the above-described embodiments can be appropriately combined except that embodiments are mutually related and apparently impossible to be combined. Further, in the above-described embodiments, elements constituting the embodiments are not necessarily required except that elements are clearly specified as necessary or theoretically necessary.

The acquiring unit, the output unit and the method thereof disclosed in the present disclosure may be accomplished by a dedicated computer constituted of a processor and a memory programmed to execute one or more functions embodied by computer programs. Alternatively, the acquiring unit, the output unit and the method thereof disclosed in the present disclosure may be accomplished by a dedicated computer provided by a processor configured of one or more dedicated hardware logic circuits. Further, the acquiring unit, the output unit and the method thereof disclosed in the present disclosure may be accomplished by one or more dedicated computer where a processor and a memory programmed to execute one or more functions, and a processor configured of one or more hardware logic circuits are combined. Furthermore, the computer programs may be stored, as instruction codes executed by the computer, into a computer readable non-transitory tangible recording media.

According to the above-described embodiments, the spatial information output apparatus 60 is included in the automatic driving ECU 50, that is, the space information output apparatus 60 is integrated into the automatic driving ECU 50. However, the spatial information output apparatus 60 is not limited to an apparatus integrated into the ECU 50. The spatial information output unit 60 may be provided in the own vehicle 20 separately from the automatic driving ECU 50.

According to the above-described embodiments, the second distance L2, the fourth distance L4, the seventh distance L7, the eighth distance L8 and the ninth distance L9 are the same. However, the second distance L2, the fourth distance L4, the seventh distance L7, the eighth distance L8 and the ninth distance L9 are not limited to the same distance, but they may be different from each other.

According to the above-described embodiments, the third distance L3, the fifth distance L5 and the sixth distance L6 are the same. However, the third distance L3, the fifth distance L5 and the sixth distance L6 are not limited to the same distance, but they may be different from each other.

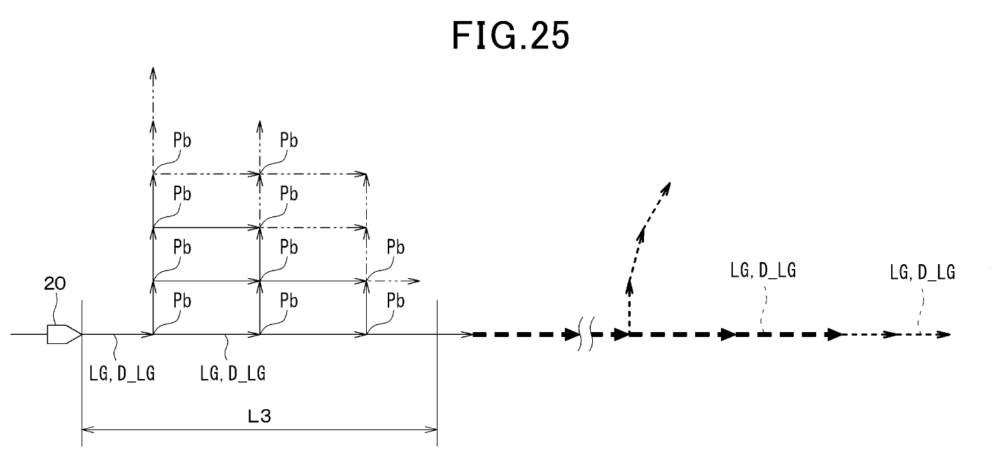

According to the above-described embodiments, the spatial information output unit 66 outputs the third area data extracted at step S500 in the case where the location of the own vehicle 20 is in an ordinary road and the third area data does not include an expressway or an ordinary road. In this case, as shown in FIG. 25, the spatial information output unit 66 may exclude data related to the ordinary road outside an area defined by a lane group LG of which the start point is the Nth branch point Pb from the location of the own vehicle 20 to the end point thereof. Note that N is, for example 3. In FIG. 25, the excluded lane group LG is indicated by a two-dot chain line. Further, similar to the above-described configuration, the spatial information output unit 66 may exclude, for respective extracted areas, data related to the ordinary road outside an area defined by a lane group LG of which the start point is the Nth branch point Pb from the location of the own vehicle 20 to the end point thereof.

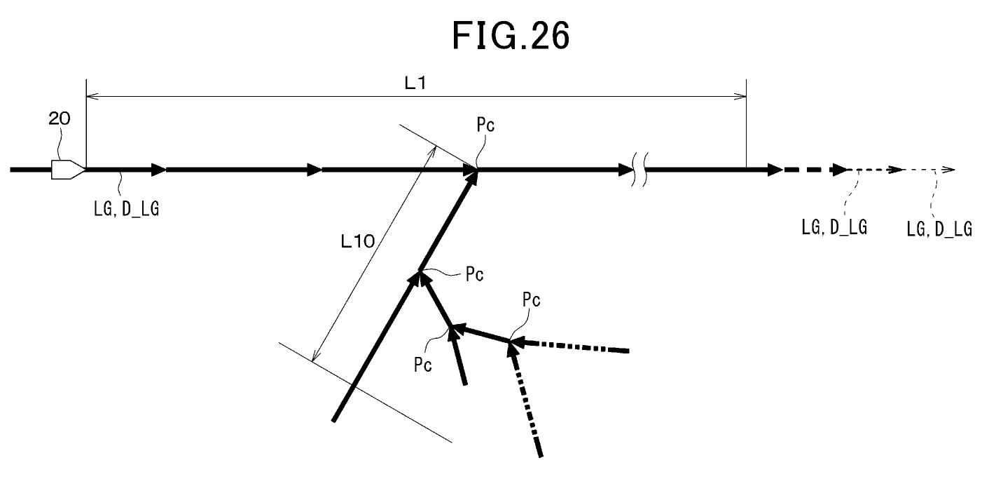

According to the above-described embodiments, the spatial information output unit 66 outputs the first area data extracted at step S300 in the case where the location of the own vehicle 20 is in an expressway and the first area data does not include a road of which the type is different from the expressway. In this case, as shown in FIG. 26, the spatial information output unit 66 sets a tenth area as an area from the first junction Pc with respect to the location of the own vehicle 20 to the tenth distance L10. The junction point Pc refers to a point at which a plurality of lane groups Ls are merged into one lane group LG. The tenth distance L10 is shorter than or equal to the third distance L3, for example, 200 meters. Further, the spatial information output unit 66 may exclude data related to a road in the tenth area, outside an area from the first junction point Pc to a start point of a lane group LG where the start point is the Nth junction point with respect to the first junction point Pc. Note that N is, for example, 3. In FIG. 26, the excluded lane group LG is indicated by a two-dot chain line. Moreover, similar to the above-described configurations, the spatial information output unit 66 may exclude, for respective extracted areas, data related to a road outside an area from the first junction point Pc to a start point of a lane group LG where the start point is the Nth junction point with respect to the first junction point Pc.

According to the above-described embodiments, the program of the spatial information output unit 66 is executed when the navigation system is not performing a route guidance. However, the program of the spatial information output unit 66 may be executed when the navigation system 26 is performing a route guidance.

The above-described respective embodiments may be appropriately combined.

### Aspects of the present disclosure

### Aspect 1

A spatial information output apparatus comprising:

an acquiring unit that acquires a map data including a location of an own vehicle and a type of a road; and

an output unit that extracts a reduced map data from an extraction area of the map data, and outputs the reduced map data of the extraction area, the extraction area being from the location of the own vehicle to a setting distance in the map data,

wherein

the output unit is configured to change the setting distance based on the type of the road on which the own vehicle is located.

### Aspect 2

The spatial information output apparatus according to aspect 1,

wherein

the output unit is configured to set the setting distance to be a first distance when the location of the own vehicle is in a first road, and extract, from the map data, a first area data as the reduced map data in a first area, the first area being from the location of the own vehicle to the first distance in the map data;

the output unit is configured to set the setting distance to be a second distance shorter than the first distance when the location of the own vehicle is in a second road different from the first road, and extract, from the map data, a second area data as the reduced map data in a second area, the second area being from the location of the own vehicle to the second distance in the map data; and

the output unit is configured to set the setting distance to be a third distance shorter than the second distance when the location of the own vehicle is in a third road different from the first road and the second road, and extract, from the map data, a third area data as the reduced map data in a third area, the third area being from the location of the own vehicle to the third distance in the map data.

### Aspect 3

The spatial information output apparatus according to aspect 2,

wherein

the output unit is configured to change, when the location of the own vehicle is in the first road and the first area data includes the second road, the setting distance to be a fourth distance from the first distance, and extract, from the map data, a fourth area data as the reduced map data in a fourth area, the fourth area being from the location of the own vehicle to the fourth distance, the fourth distance being longer than or equal to the second distance and shorter than the first distance.

### Aspect 4

The spatial information output apparatus according to aspect 3,

wherein

the output unit is configured to change, when the first area data includes the third road and the third area data includes the third road, the setting distance to be a fifth distance from the first distance, and extract, from the map data, a fifth area data as the reduced map data in a fifth area, the fifth area being from the location of the own vehicle to the fifth distance, the fifth distance being longer than or equal to the third distance and shorter than the second distance; and

the output unit is configured to exclude, when first area data includes the third road and the third road is outside the third area, data related to the third road outside the third area.

### Aspect 5

The spatial information output apparatus according to aspect 4,

wherein

the output unit is configured to change, when the location of the own vehicle is in the second road and the second area data includes the third road and the third area data includes the third road, the setting distance to be a sixth distance from the second distance, and extract, from the map data, a sixth area data as the reduced map data in a sixth area, the sixth area being from the location of the own vehicle to the sixth distance, the sixth distance being longer than or equal to the third distance and shorter than the second distance.

### Aspect 6

The spatial information output apparatus according to aspect 5,

wherein

the output unit is configured to exclude, when the second area data includes the third road and the third road is outside the third area, data related to the third road outside the third area from the second area data.

### Aspect 7

The spatial information output apparatus according to aspects 5 or 6,

wherein

the output unit is configured to change, when the sixth area data includes the first road, the setting distance to be a seventh distance from the sixth distance, and extract, from the map data, a seventh area data as the reduced map data in a seventh area, the seventh area being from the location of the own vehicle to the seventh distance, the seventh distance being longer than or equal to the second distance and shorter than the first distance; and

the output unit is configured to change, when the sixth area data includes the second road, the setting distance to be the seventh distance, and extract, from the map data, the seventh area data as the reduced map data in the seventh area.

### Aspect 8

The spatial information output apparatus according to aspect 7,

wherein

the output unit is configured to change, when the location of the own vehicle is in the third road and the third area data includes the first road, the setting distance to be an eighth distance from the third distance, and extract, from the map data, an eighth area data as the reduced map data in an eighth area, the eighth area being from the location of the own vehicle to the eighth distance, the eighth distance being longer than or equal to the second distance and shorter than the first distance.

### Aspect 9

The spatial information output apparatus according to aspect 8,

wherein

the output unit is configured to exclude data related to the first road outside the third area from the eighth area data.

### Aspect 10

The spatial information output apparatus according to aspects 8 or 9,

wherein

the output unit is configured to change, when the third area data includes the second road, the setting distance to be a ninth distance from the third distance, and extract, from the map data, an ninth area data as the reduced map data in a ninth area, the ninth area being from the location of the own vehicle to the ninth distance, the ninth distance being longer than or equal to the second distance and shorter than the first distance.

### Aspect 11

The spatial information output apparatus according to aspect 10,

wherein

the output unit is configured to exclude data related to the second road outside the third area from the ninth area data.

### Aspect 12

The spatial information output apparatus according to any one of aspects 2 to 11,

wherein

the map data includes a plurality of lane groups and branch points;

the lane group is a group of lanes indicating a road;

the branch point is a point at which one lane group is branched into a plurality of lane groups; and

the output unit is configured to exclude data related to the third road outside an area defined by a lane group of which the start point is a Nth branch point from the location of the own vehicle to the end point thereof, where N is a natural number.

### Aspect 13

The spatial information output apparatus according to any one of aspects 1 to 12,

wherein

the output unit is configured to change the setting distance when a route guidance of the own vehicle is not being performed, and not to change the setting distance when a route guidance of the own vehicle is being performed.

### Aspect 14

A method for outputting spatial information comprising:

acquiring a map data including a location of an own vehicle and a type of a road;

extracting a reduced map data from an extraction area of the map data;

outputting the reduced map data of the extraction area, the extraction area being from the location of the own vehicle to a setting distance in the map data; and

changing the setting distance based on the type of the road on which the own vehicle is located.

### Aspect 15

A program stored in a non-transitory tangible computer readable recording media, causing a computer to cause a spatial information apparatus to serve as units comprising:

an acquiring unit that acquires a map data including a location of an own vehicle and a type of a road; and

an output unit that extracts a reduced map data from an extraction area of the map data and outputs the reduced map data of the extraction area, the extraction area being from the location of the own vehicle to a setting distance in the map data,

wherein

the output unit is configured to change the setting distance based on the type of the road on which the own vehicle is located.

### Conclusion

The present disclosure provides a spatial information output apparatus, a spatial information output method and a spatial information output program, capable of suppressing an increase in pieces of unnecessary information in a map information to be outputted.

A first aspect of the present disclosure is a spatial information output apparatus is provided with an acquiring unit that acquires a map data including a location of an own vehicle and a type of a road; and an output unit that extracts a reduced map data from an extraction area of the map data, and outputs the reduced map data of the extraction area, the extraction area being from the location of the own vehicle to a setting distance in the map data, in which the output unit is configured to change the setting distance based on the type of the road on which the own vehicle is located.

A second aspect of the present disclosure is a method for outputting spatial information including: acquiring a map data including a location of an own vehicle and a type of a road; extracting a reduced map data from an extraction area of the map data; outputting the reduced map data of the extraction area, the extraction area being from the location of the own vehicle to a setting distance in the map data; and changing the setting distance based on the type of the road on which the own vehicle is located.

A third aspect of the present disclosure is a program for outputting spatial information in which the program is stored in a non-transitory tangible computer readable recording media, causing a computer to cause a spatial information apparatus to serve as units including: an acquiring unit that acquires a map data including a location of an own vehicle and a type of a road; and an output unit that extracts a reduced map data from an extraction area of the map data and outputs the reduced map data of the extraction area, the extraction area being from the location of the own vehicle to a setting distance in the map data. The output unit is configured to change the setting distance based on the type of the road on which the own vehicle is located.

Thus, a map data (reduced map data) in an area suitable for the type of road is extracted among the map data. Hence, the map data having an appropriate information quantity is extracted. Hence, an increase in the quantity of unnecessary information of the map data Md to be outputted can be avoided.

What is claimed is:

1. A spatial information output apparatus comprising:
an acquiring unit that acquires a map data including a location of an own vehicle and a type of a road; and
an output unit that extracts a reduced map data from an extraction area of the map data, and outputs the reduced map data of the extraction area, the extraction area being from the location of the own vehicle to a setting distance in the map data,
wherein
the output unit is configured to change the setting distance based on the type of the road on which the own vehicle is located.

2. The spatial information output apparatus according to claim 1,
wherein
the output unit is configured to set the setting distance to be a first distance when the location of the own vehicle is in a first road, and extract, from the map data, a first area data as the reduced map data in a first area, the first area being from the location of the own vehicle to the first distance in the map data;
the output unit is configured to set the setting distance to be a second distance shorter than the first distance when the location of the own vehicle is in a second road different from the first road, and extract, from the map data, a second area data as the reduced map data in a second area, the second area being from the location of the own vehicle to the second distance in the map data; and
the output unit is configured to set the setting distance to be a third distance shorter than the second distance when the location of the own vehicle is in a third road different from the first road and the second road, and extract, from the map data, a third area data as the reduced map data in a third area, the third area being from the location of the own vehicle to the third distance in the map data.

3. The spatial information output apparatus according to claim 2,
wherein
the output unit is configured to change, when the location of the own vehicle is in the first road and the first area data includes the second road, the setting distance to be a fourth distance from the first distance, and extract, from the map data, a fourth area data as the reduced map data in a fourth area, the fourth area being from the location of the own vehicle to the fourth distance, the fourth distance being longer than or equal to the second distance and shorter than the first distance.

4. The spatial information output apparatus according to claim 3,
wherein
the output unit is configured to change, when the first area data includes the third road and the third area data includes the third road, the setting distance to be a fifth distance from the first distance, and extract, from the map data, a fifth area data as the reduced map data in a fifth area, the fifth area being from the location of the own vehicle to the fifth distance, the fifth distance being longer than or equal to the third distance and shorter than the second distance; and
the output unit is configured to exclude, when first area data includes the third road and the third road is outside the third area, data related to the third road outside the third area.

5. The spatial information output apparatus according to claim 4,
wherein
the output unit is configured to change, when the location of the own vehicle is in the second road and the second area data includes the third road and the third area data includes the third road, the setting distance to be a sixth distance from the second distance, and extract, from the map data, a sixth area data as the reduced map data in a sixth area, the sixth area being from the location of the own vehicle to the sixth distance, the sixth distance being longer than or equal to the third distance and shorter than the second distance.

6. The spatial information output apparatus according to claim 5,
wherein
the output unit is configured to exclude, when the second area data includes the third road and the third road is outside the third area, data related to the third road outside the third area from the second area data.

7. The spatial information output apparatus according to claim 5,
wherein
the output unit is configured to change, when the sixth area data includes the first road, the setting distance to be a seventh distance from the sixth distance, and extract, from the map data, a seventh area data as the reduced map data in a seventh area, the seventh area being from the location of the own vehicle to the seventh distance, the seventh distance being longer than or equal to the second distance and shorter than the first distance; and
the output unit is configured to change, when the sixth area data includes the second road, the setting distance to be the seventh distance, and extract, from the map data, the seventh area data as the reduced map data in the seventh area.

8. The spatial information output apparatus according to claim 7,
wherein
the output unit is configured to change, when the location of the own vehicle is in the third road and the third area data includes the first road, the setting distance to be an eighth distance from the third distance, and extract, from the map data, an eighth area data as the reduced map data in an eighth area, the eighth area being from the location of the own vehicle to the eighth distance, the eighth distance being longer than or equal to the second distance and shorter than the first distance.

9. The spatial information output apparatus according to claim 8,
wherein
the output unit is configured to exclude data related to the first road outside the third area from the eighth area data.

10. The spatial information output apparatus according to claim 8,
wherein
the output unit is configured to change, when the third area data includes the second road, the setting distance to be a ninth distance from the third distance, and extract, from the map data, an ninth area data as the reduced map data in a ninth area, the ninth area being from the location of the own vehicle to the ninth distance, the ninth distance being longer than or equal to the second distance and shorter than the first distance.

11. The spatial information output apparatus according to claim 9,
wherein
the output unit is configured to change, when the third area data includes the second road, the setting distance to be a ninth distance from the third distance, and extract, from the map data, an ninth area data as the reduced map data in a ninth area, the ninth area being from the location of the own vehicle to the ninth distance, the ninth distance being longer than or equal to the second distance and shorter than the first distance.

12. The spatial information output apparatus according to claim 10,
wherein
the output unit is configured to exclude data related to the second road outside the third area from the ninth area data.

13. The spatial information output apparatus according to claim 2,
wherein
the map data includes a plurality of lane groups and branch points;
the lane group is a group of lanes indicating a road;
the branch point is a point at which one lane group is branched into a plurality of lane groups; and
the output unit is configured to exclude data related to the third road outside an area defined by a lane group of which the start point is a Nth branch point from the location of the own vehicle to the end point thereof, where N is a natural number.

14. The spatial information output apparatus according to claim 1,
wherein
the output unit is configured to change the setting distance when a route guidance of the own vehicle is not being performed, and not to change the setting distance when a route guidance of the own vehicle is being performed.

15. The spatial information output apparatus according to claim 2,
wherein
the output unit is configured to change the setting distance when a route guidance of the own vehicle is not being performed, and not to change the setting distance when a route guidance of the own vehicle is being performed.

16. A method for outputting spatial information comprising:
acquiring a map data including a location of an own vehicle and a type of a road;
extracting a reduced map data from an extraction area of the map data;
outputting the reduced map data of the extraction area, the extraction area being from the location of the own vehicle to a setting distance in the map data; and
changing the setting distance based on the type of the road on which the own vehicle is located.

17. A program stored in a non-transitory tangible computer readable recording media, causing a computer to cause a spatial information apparatus to serve as units comprising:
an acquiring unit that acquires a map data including a location of an own vehicle and a type of a road; and
an output unit that extracts a reduced map data from an extraction area of the map data and outputs the reduced map data of the extraction area, the extraction area being from the location of the own vehicle to a setting distance in the map data,
wherein
the output unit is configured to change the setting distance based on the type of the road on which the own vehicle is located.
